(19) United States
(12) Patent Application Publication
(10) Pub. No.: US 2010/0072864 A1
(43) Pub. Date: Mar. 25, 2010

(54) Motor Assembly with Sensor Target on Motor Rotor and Method of Forming Same

(75) Inventors: Dan H. Nguy, Royal Oak, MI (US); RONALD M. WOZNIAK, Auburn Hills, MI (US); KEVIN P. COLEMAN, Livonia, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/234,876

(22) Filed: Sep. 22, 2008

(51) Int. Cl. H02K 11/00; H02K 15/00

(52) U.S. Cl. 310/68 B; 29/596

(57) ABSTRACT

A motor assembly is provided that includes a rotor having a plurality of coaxial rotor laminations, a conductive end ring adjacent the rotor laminations that establishes an axial end of the rotor; and a target member supported by the end ring and rotatable with the rotor. A sensor is operable to monitor, for example, speed and/or angular position of the target member as the rotor rotates. A method of forming a motor assembly includes providing a sensor target and a sensor operable to determine the position of the sensor target. The method includes connecting the sensor target with a motor rotor end ring such that the sensor target is supported by the motor rotor end ring for common rotation therewith and may be sensed by the sensor. Connecting the sensor target to the end ring may be by overcasting the sensor target onto the motor rotor end ring.

### TECHNICAL FIELD

The invention relates to a motor assembly with a sensor target on the motor rotor end ring, and a method of forming the same.

### BACKGROUND OF THE INVENTION

Electric motor assemblies have a rotatable rotor. A stator surrounds the rotor and interacts with the rotor to cause rotation of the rotor. In an induction motor, when electrical windings are energized, a magnetic field acts on the rotor to turn the rotor. The rotor may be formed with a plurality of rotor laminations stacked together to form the core magnetic material of the rotor. In certain applications, such as in hybrid automotive powertrains, it may be desirable to know the speed and angular orientation of the rotor.

### SUMMARY OF THE INVENTION

A motor assembly is provided that includes a rotor having a plurality of coaxial rotor laminations, a conductive end ring adjacent the rotor laminations that establishes an axial end of the rotor; and a target member supported by the end ring and rotatable with the rotor. A sensor is operable to monitor the target member as the rotor rotates. For example, speed and/or angular position of the target member may be monitored. In some embodiments, the target member may be a rotor lamination, either identical to those stacked within the rotor, or modified to increase the precision with which the position is sensed. Use of rotor laminations as a target member may improve performance over other types of target members due to low associated hysteresis and eddy current loss.

A method of forming a motor assembly includes providing a sensor target and a sensor operable to determine the position of the sensor target. The method includes connecting the sensor target with a motor rotor end ring such that the sensor target is supported by the motor rotor end ring for common rotation therewith and may be sensed by the sensor when the sensor is mounted adjacent the end ring. Connecting the sensor target to the end ring may be by overcasting the sensor target onto the motor rotor end ring.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in end view of a first embodiment of a sensor target that is a modified rotor lamination;

FIG. 2 is a schematic partially cross-sectional and fragmentary side view illustration of a first embodiment of a motor assembly including a rotor with an end ring, stacked rotor laminations, and the modified rotor lamination of FIG. 1 adhered onto the end ring to serve as a sensor target for a sensor mounted to the motor housing;

FIG. 3 is a schematic illustration in end view of a second embodiment of a sensor target that is an unmodified rotor lamination;

FIG. 4 is a schematic partially cross-sectional and fragmentary side view illustration of a second embodiment of a motor assembly including a rotor with an end ring, stacked rotor laminations, and the rotor lamination of FIG. 3 overcasted into the end ring to serve as a sensor target for the sensor mounted to the motor housing;

FIG. 5 is a schematic illustration in end view of a third embodiment of a sensor target;

FIG. 6 is a schematic partially cross-sectional and fragmentary side view illustration of a third embodiment of a motor assembly including a rotor with an end ring, stacked rotor laminations, and the sensor target of FIG. 5 overcasted into the end ring;

FIG. 7 is a flow diagram illustrating a method of forming a motor assembly; and

FIG. 8 is cross-sectional illustration of a die for overcasting the sensor target onto the end ring of FIGS. 3 and 4, according to the method of FIG. 7.

### DESCRIPTION OF THE PREFERRED EMBODIMENTS

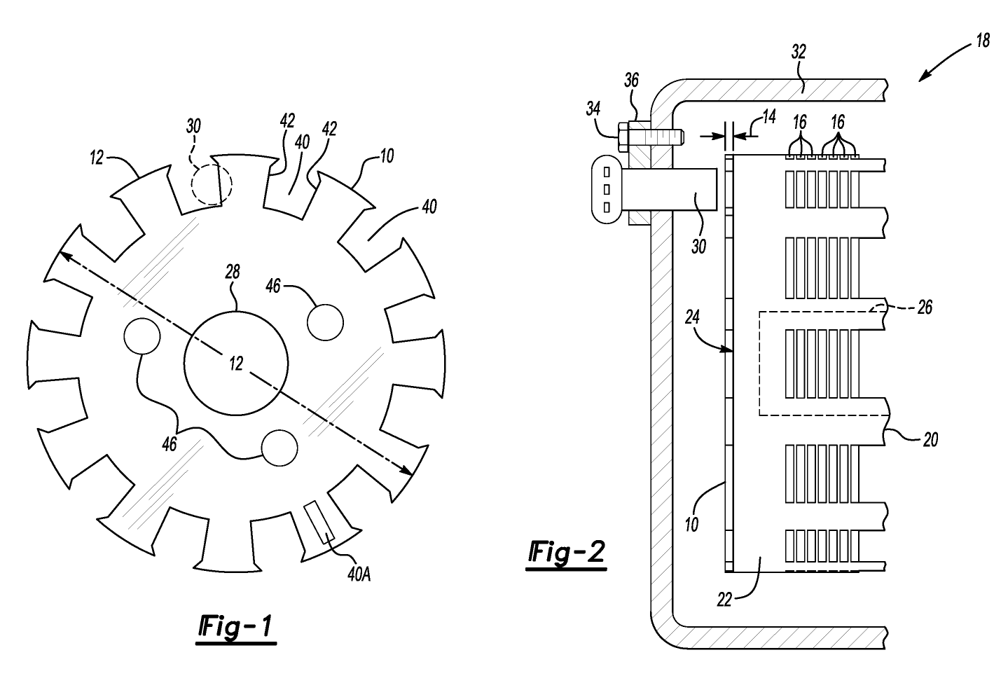

Referring to the drawings, wherein like reference numbers refer to like components, FIG. 1 shows a sensor target 10, also referred to herein as a target member, in the form of a rotor lamination. The sensor target 10 is substantially identical in diameter 12 and thickness 14 (see FIG. 2) as each of a plurality of rotor laminations 16 stacked axially and concentric with one another, as shown in the motor assembly 18 of FIG. 2. The rotor laminations 16 are cast into a rotor 20 that includes a cast end ring 22. The rotor laminations 16, as well as the target sensor 10, are a ferrous material, establishing a magnetic core for the rotor 20. The end ring 22 is at an axial end (i.e., at end face 24) of the rotor 20, and is a nonferrous, but conductive, material, such as an aluminum alloy.

In the embodiment of FIG. 2, the sensor target 10 is adhered to end face 24 of the end ring 22 by any suitable adhesive or bonding material. Thus, when a rotor shaft 26 (indicated in phantom in FIG. 2) is inserted through central openings in each of the rotor laminations 16, similar to central opening 28 in sensor target 10, the rotor 20, including the sensor target 10 connected thereto, rotates.

A sensor 30 is mounted to a motor casing 32 partially surrounding the rotor 20 via a fastener 34 and a sensor mounting plate 36. (A stator is mounted to the motor casing 32 and circumferentially surrounds the rotor 20 as understood by those skilled in the art, but is not shown in FIG. 1 for purposes of clarity in the drawing.) The sensor 30 is spaced axially from the rotor 20 and positioned radially to align with the slots 40 in the sensor target 10, as indicated by the phantom depiction of the sensor 30 in FIG. 1. The sensor target 10 defines edges 42 at the slots 40. The sensor target 10 is a modified version of the rotor laminations 16, in that an additional slot 40A is formed to increase the number of edges. Although only one additional slot 40A creating two additional edges is shown, any number of additional edges may be formed by any number of additional slots or otherwise. The sensor 30 may be a variable reluctance speed sensor that creates a magnetic field. As the sensor target 10 rotates, the field is interrupted when the ferrous lamination passes the sensor, and then is reestablished when the aluminum alloy rotor material that fills the adjacent slot 40 passes the sensor. Thus, the field changes with each edge 42 passing the sensor 30, enabling the speed and/or angular position of the sensor target 10 to be monitored. An increase in the number of edges between ferrous and nonferrous material passing the sensor 30 allows the sensor 30 to monitor the angular position of the rotor 20 with greater precision. The changing field is captured as sensor signals that are relayed by the sensor 30 to a controller (not shown) configured with an algorithm that is operable to determine from the sensor signals the speed and/or angular position of the rotor 20. Any other type of sensor operable to sense the passing of the ferrous sensor target 10 and the nonferrous end ring 22 may be used. For example, a Hall Effect sensor may be used.

Openings 46 in the sensor target 10 may be used for piloting the sensor target 10 onto the end ring 22. Similar openings are formed in the rotor laminations 16 for stacking the laminations 16 together, and to hold the laminations 16 apart via spacers, prior to die casting the end ring 22 therearound. Alternatively, in lieu of adhering the sensor target 10 to the end ring 22, fasteners may be inserted through the openings 46 to connect the sensor target 10 to the end ring 22.

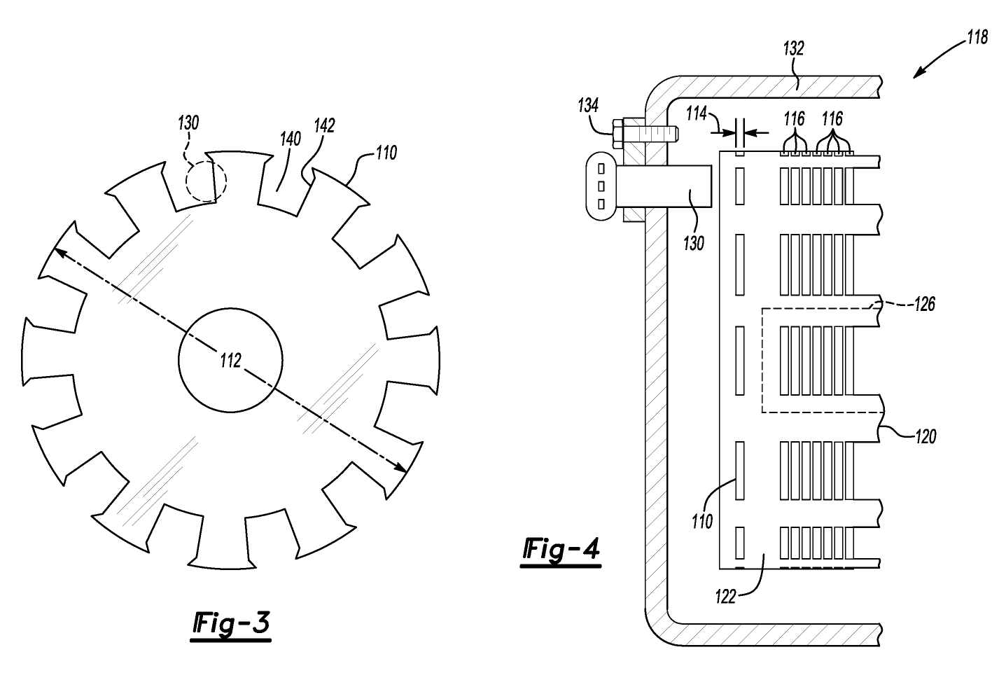

Referring to FIGS. 3 and 4, a second embodiment of a sensor target 110, also referred to herein as a target member, and a motor assembly 118 are shown. The sensor target 110 is similar in all aspects to sensor target 10 of FIG. 1, except that it has the same number of slots 140 and edges 142, in addition to the same diameter 112 and thickness 114, as the rotor laminations 116. Thus, sensor target 110 is an unmodified rotor lamination and may be purchased in bulk with the laminations to be used for the rotor, stored with the rotor laminations, etc., potentially reducing costs. Instead of being adhered to the rotor 120, the sensor target 110 is overcasted in the end ring 122, according to a method of forming described hereinafter. A sensor 130 is bolted to the casing 132 via bolt 134. The sensor 130 is positioned in radial alignment with the slots 140 and edges 142 of the sensor target 110, as indicated in FIG. 4 as well as in phantom in FIG. 3. Thus, as the target sensor 110 rotates with the rotor 120 (which rotates on rotor shaft 126), the rotational speed and angular position of the rotor 120 are determined by a controller via sensor signals relayed by the sensor 130 (not shown, but operatively connected to the sensor 130).

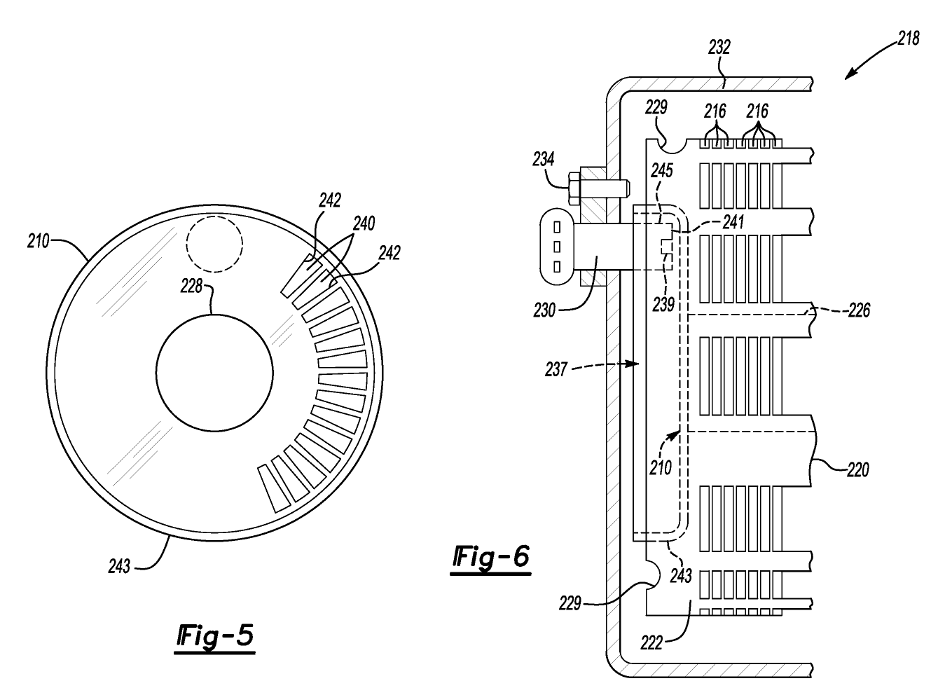

Referring to FIGS. 5 and 6, sensor target 210 is of a ferrous material and has a central opening 228 and a plurality of slots 240, with the sensor target 210 defining edges 242 on either side of each slot 240. As shown in FIG. 6, the sensor target 210 is overcasted into a nonferrous end ring 222, such as an aluminum alloy end ring, of a motor rotor 220 of motor assembly 218 according to a method of forming described hereinafter. The motor rotor 220 has a plurality of axially spaced rotor laminations 216, which have a shape similar to the sensor target 110 and rotor laminations 116 of FIG. 3.

The sensor target 210 has a flanged circumferential extension 243 extending axially therefrom. In FIG. 6, the extension 243 extends out of the end ring 222, although the overcasting of the sensor target 210 into the end ring 222 may be such that the entire sensor target 210 is embedded in the end ring 222, if desired. Thus, when a rotor shaft 226 (indicated in phantom in FIG. 6) inserted through central openings in each of the rotor laminations 216, similar to central opening 228 in sensor target 210, as well as through central opening 228, the rotor 220 and the sensor target 210 connected thereto rotate with the rotor shaft 226. Alternatively, the sensor target 210 need not have the central opening 228, and may be piloted onto the end ring 222 in alignment with the rotor laminations 216 by any means, including by piloting rods extending through piloting holes (not shown in the embodiment of FIGS. 5-6). Rotor material may be removed from various areas 229 as necessary to balance the end ring 222.

A sensor 230 is bolted to motor casing 232 via bolt 234. The sensor 230 is positioned in radial alignment with the slots 240 and edges 242 of the sensor target 210, as indicated in FIG. 6 as well as in phantom in FIG. 5. Thus, as the target sensor 210 rotates with the rotor 220 (which rotates on rotor shaft 226), the rotational speed and angular position of the rotor 220 is determined by a controller (not shown) via sensor signals relayed by the sensor 230. It is apparent in FIG. 6 that the sensor 230 extends into a cavity 237 formed by the target sensor 210. A sensing element 239, such as a magnetic pickup, placed at an axial end 241 of the sensor 230 is positioned to monitor the speed and/or angular position of the sensor target 210 via the radial slots 240 and edges 242 passing thereby. Alternatively or in addition, slots may be formed or machined in the circumferential extension 243 and a sensing element could be placed on an outer radial surface 245 of the sensor 230 to monitor the speed and angular position of the sensor target 210 via slots in the angular extension 243.

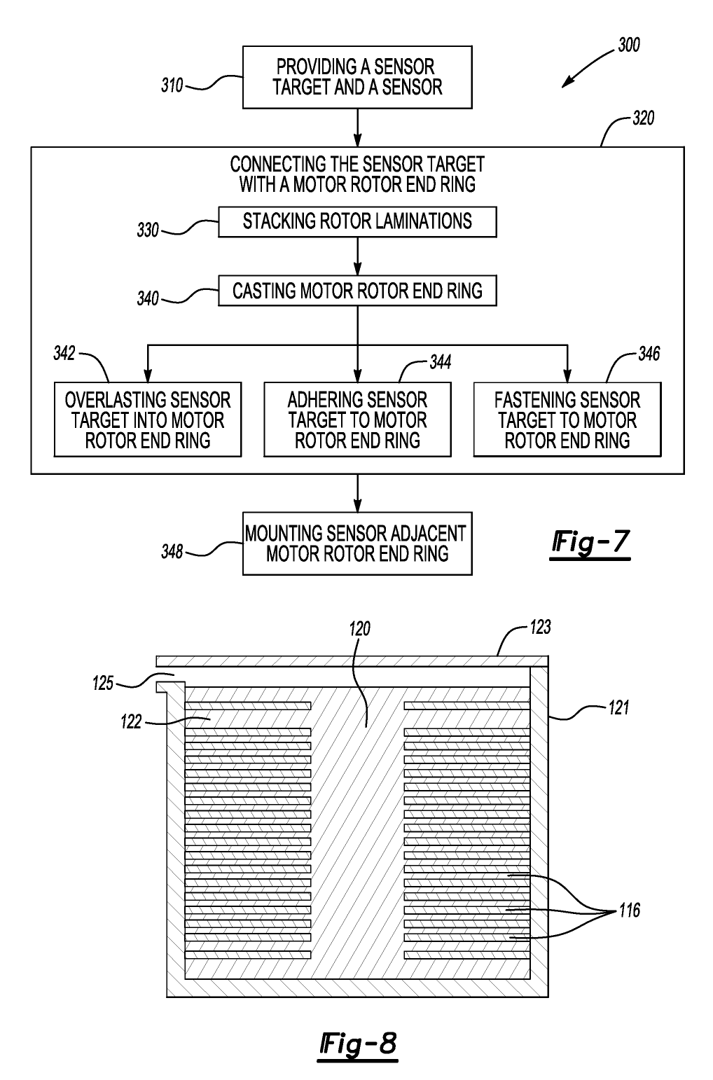

Referring to FIGS. 7 and 8, a method 300 of forming a motor assembly is described with respect to the motor assembly 118 of FIGS. 3 and 4, although the method 300 is not limited to forming the motor assembly 118, and may be used to form other embodiments of motor assemblies. The method 300 includes providing a sensor target and a sensor, step 310, such as sensor target 110 and sensor 130 of FIG. 4.

Next, the sensor target is connected with a motor rotor end ring for common rotation therewith in step 320. Although the connecting step 320 may be accomplished in a variety of ways, for a motor rotor having stacked rotor laminations, such as rotor 120 of FIG. 4, the connecting step 320 would first include stacking the rotor laminations in step 330 and then casting the motor rotor end ring integrally with the stacked motor laminations. As shown in FIG. 8, upper die 123 is removable from the lower die 121 to allow access to the cast rotor 120. An access opening 125 permits the casting material, such as aluminum alloy, to be injected into the die 121, 123. Spacers or inserts extending through piloting openings in the rotor laminations 116, or placed between adjacent rotor laminations, may be employed to maintain the spacing of the rotor laminations 116 prior to casting. Material, from which the rotor 120 is formed, such as aluminum alloy, is then poured into the casting die 121, 123 and fills the spaces between the rotor laminations 116, fills the slots 140 (shown in FIGS. 3 and 4) and forms the end ring 122, in step 340, casting the motor rotor end ring. The same casting step 320 may include substep 342, overcasting the sensor target 110 into the motor rotor end ring 122. As used herein, “overcasting” means casting material over a component, which may be a previously cast or formed component, or which may be cast at the same time as the overcast portion. Accordingly, the overcasting step 342 may be carried out at the same time as the casting step 340, if spacers or inserts are used to correctly position the sensor target 110 from the rotor lamination 116. Alternatively, the end ring 122 may be cast in step 340, and then the rotor lamination may be placed on the outer surface of the end ring 122, preferably after machining the outer surface, and then overcast to become integral with the end ring 122 and rotor 120 in step 342. After casting step 340, an opening for shaft 126 may be machined or otherwise provided through the rotor 120 to permit connection of the rotor 120 to rotor shaft 126.

As an alternative to the overcasting step 342, step 320 may include step 344, adhering the sensor target to the motor rotor end ring, as described with respect to sensor target 10 and end ring 22 of FIGS. 1 and 2. As yet another alternative, the sensor target may be fastened to the motor rotor end ring in step 346, using bolts or other fasteners, such as through openings 46 in FIG. 1, in lieu of adhering the target to the end ring.

After forming the rotor 120 with sensor target connected thereto, the method 300 further includes mounting the sensor adjacent the motor rotor end ring, step 348. In the embodiment of FIGS. 3-4, the sensor 130 is mounted to the stationary motor housing 132, axially adjacent the sensor target 110. Within the scope of the invention, the sensor 130 could be mounted anywhere that enables the sensor 130 to be sufficiently close to the sensor target 110 and with relative rotation between the sensor target 110 and the sensor 130 to determine the changing magnetic field due to the rotating sensor target 110.

Accordingly, an improved motor assembly having a relatively low cost target sensor enables an accurate determination of rotor speed and angular position and is formed according to an efficient method, which may include overcasting the target sensor into the rotor end ring.

While the best modes for carrying out the invention have been described in detail, those familiar with the art to which this invention relates will recognize various alternative designs and embodiments for practicing the invention within the scope of the appended claims.

1. A motor assembly comprising:
a rotor having:
a plurality of coaxial rotor laminations;
a conductive end ring adjacent the rotor laminations and establishing an axial end of the rotor; and
a target member supported by the end ring and rotatable with the rotor;
wherein the target member is overcasted into the end ring; and
a sensor operable to monitor the target member as the rotor rotates.

2. The motor assembly of claim 1, wherein the target member has a plurality of slots therein defining a plurality of edges; and wherein the sensor is operable to monitor the edges as they rotate past the sensor for determining at least one of rotor speed and rotor angular position.

3. The motor assembly of claim 1, wherein the target member is substantially identical to one of the rotor laminations.

4. The motor assembly of claim 1, wherein the target member is substantially identical in thickness and diameter with one of the rotor laminations; wherein the rotor laminations each have a first number of slots defining a first number of edges, and wherein the target member has a second number of slots defining a second number of edges different than the first number of edges.

5. The motor assembly of claim 1, wherein the target member is a ferrous material and the end ring is a nonferrous material.

6. A method of forming a motor assembly comprising:
providing a rotor including;
a plurality of coaxial rotor laminations,
a motor rotor end ring adjacent the rotor laminations and establishing an axial end of the rotor, and
a sensor target; and
providing a sensor operable to determine one of speed and position of the sensor target; and
overcasting the sensor target into a motor rotor end ring such that the sensor target is supported by the motor rotor end ring for common rotation therewith and may be sensed by the sensor when the sensor is mounted adjacent the end ring.

7. (canceled)

8. The method of claim 6, further comprising:
casting the motor rotor end ring prior to overcasting the sensor target onto the motor rotor end ring.

9. The method of claim 8, further comprising:
stacking rotor laminations; and wherein the motor rotor end ring is cast around the stacked rotor laminations.

10. (canceled)

11. (canceled)

12. The method of claim 6, wherein the sensor target is a rotor lamination.

13. A method of forming a motor assembly comprising:
providing a plurality of coaxial rotor laminations;
providing a motor rotor end ring adjacent the rotor laminations;
providing a sensor target; and
overcasting the sensor target onto the motor rotor end ring such that the sensor target is supported by the motor rotor end ring for common rotation therewith in order to be sensed by a sensor when the sensor is mounted adjacent the end ring.

14. The method of claim 13, further comprising:
mounting the sensor adjacent the motor rotor end ring.

15. The method of claim 13, wherein the motor rotor end ring supports a plurality of slotted rotor laminations; and wherein the sensor target is substantially identical to one of the slotted rotor laminations.

16. The motor assembly of claim 1, wherein the end ring is cast around the plurality of coaxial rotor laminations.
